(19) United States
(12) Patent Application Publication
(10) Pub. No.: US 2024/0005807 A1
(43) Pub. Date: Jan. 4, 2024

(54) LEARNING, IDENTIFYING, AND LAUNCHING OPERATIONS IN A DIGITAL LEARNING ENVIRONMENT

(71) Applicant: Lenovo (Singapore) Pte. Ltd., New Tech Park (SG)

(72) Inventors: Allen Richey, Frisco, TX (US); Inna Zolin, Cary, NC (US); Matthew Fardig, Boonville, IN (US)

(21) Appl. No.: 17/854,431

(22) Filed: Jun. 30, 2022

(51) Int. Cl. G09B 5/06; G09B 5/08

(52) U.S. Cl. CPC G09B 5/065; G09B 5/067; G09B 5/08

(57) ABSTRACT

Apparatus, methods, and computer program products that can learn, identify, and launch operations in a digital learning environment are disclosed. One apparatus includes a processor and a memory that stores code executable by the processor to automatedly learn a sequential order for a set of operations performed in a digital learning environment, the set of operations including at least one feature related to the set of operations, automatedly identify, at a time subsequent to learning the set of operations in the digital learning environment, the at least one feature related to the set of operations, and automatedly launch the set of operations for the digital learning environment in the sequential order in response to identifying the at least one feature related to the set of operations at the subsequent time. Methods and computer program products that include and/or perform the operations and/or functions of the apparatus are also disclosed.

### FIELD

The subject matter disclosed herein relates to digital learning environment and more particularly relates to apparatus, methods, and program products for learning, identifying, and launching operations in a digital learning environment.

### DESCRIPTION OF THE RELATED ART

Modern school and work environments have increased the use of digital learning environment in virtual classrooms and work meetings. Current uses of digital learning environment merely allow users to manually turn features ON/OFF, one at a time. Since the features are turned ON/OFF manually, there is no relationship between the class/meeting, actions occurring therein, and the presented material. In some cases, multiple features can be operating simultaneously in which each feature needs to be individually, independently, and/or separately turned ON/OFF and/or individually, independently, and/or separately configured. Accordingly, current digital learning environment in virtual classrooms and/or virtual work meetings is not as effective and/or efficient as it otherwise could be.

### BRIEF SUMMARY

Apparatus that can learn, identify, and launch operations in a digital learning environment are disclosed. One apparatus includes a processor and a memory that stores code executable by the processor. The code is executable by the processor to automatedly learn a sequential order for a set of operations performed in a digital learning environment in which the set of operations include at least one feature related to the set of operations. The code is further executable by the processor to automatedly identify, at a time subsequent to learning the set of operations in the digital learning environment, the at least one feature related to the set of operations and automatedly launch the set of operations for the digital learning environment in the sequential order in response to identifying the at least one feature related to the set of operations at the subsequent time.

Also disclosed are methods for learning, identifying, and launching operations in a digital learning environment. One method includes automatedly learning, by a processor, a sequential order for a set of operations performed in a digital learning environment in which the set of operations include at least one feature related to the set of operations. The method further includes automatedly identifying, at a time subsequent to learning the set of operations in the digital learning environment, the at least one feature related to the set of operations and automatedly launching the set of operations for the digital learning environment in the sequential order in response to identifying the at least one feature related to the set of operations at the subsequent time.

Computer program products including a computer-readable storage device including code embodied therewith are further disclosed herein. The code is executable by a processor and causes the processor to automatedly learn a sequential order for a set of operations performed in a digital learning environment in which the set of operations include at least one feature related to the set of operations. The executable code further causes the processor to automatedly identify, at a time subsequent to learning the set of operations in the digital learning environment, the at least one feature related to the set of operations and automatedly launch the set of operations for the digital learning environment in the sequential order in response to identifying the at least one feature related to the set of operations at the subsequent time.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram of one embodiment of a computing system that can learn, identify, and launch operations in a digital learning environment;

FIGS. 2A and 2B are schematic block diagrams of various embodiments of an attendee computing device included in the computing system of FIG. 1;

FIG. 3 is a schematic block diagram of one embodiment of a memory device included in the attendee computing devices of FIGS. 2A and 2B;

FIG. 4 is a schematic block diagrams of one embodiment of a processor included in the attendee computing devices of FIGS. 2A and 2B;

FIGS. 5A and 5B are schematic block diagrams of various embodiments of a moderator computing device included in the computing system (and/or computing device) of FIG. 1;

FIG. 6 is a schematic block diagram of one embodiment of a memory device included in the moderator computing devices of FIGS. 5A and 5B;

FIG. 7 is a schematic block diagram of one embodiment of a processor included in the moderator computing devices of FIGS. 5A and 5B;

FIGS. 8A and 8B are schematic block diagrams of various embodiments of a host computing device included in the computing system of FIG. 1;

FIGS. 9A and 9B are schematic block diagrams of various embodiments of a memory device included in the host computing devices of FIGS. 8A and 8B;

FIGS. 10A and 10B are schematic block diagrams of various embodiments of a processor included in the host computing devices of FIGS. 8A and 8B; and

FIGS. 11 and 12 are flow diagrams of various embodiments of a method for learning, identifying, and launching operations in a digital learning environment.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a circuit, module, or system. Furthermore, embodiments may take the form of a program product embodied in one or more computer-readable storage devices storing machine readable code, computer-readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together and may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer-readable storage devices. Where a module or portions of a module are implemented in software, the software portions are stored on one or more computer-readable storage devices.

Any combination of one or more computer-readable media may be utilized. The computer-readable medium/media may include one or more computer-readable storage media. The computer-readable storage medium/media may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (e.g., a non-exhaustive and/or non-limiting list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the C programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to one embodiment, an embodiment, or similar language means that a particular feature, structure, or characteristic described in connection with the embodiment is included in at least one embodiment. Thus, appearances of the phrases in one embodiment, in an embodiment, and similar language throughout this specification may, but do not necessarily, all refer to the same embodiment, but mean one or more but not all embodiments unless expressly specified otherwise. The terms including, comprising, having, and variations thereof mean including but not limited to, unless expressly specified otherwise. An enumerated listing of items does not imply that any or all of the items are mutually exclusive, unless expressly specified otherwise. The terms, “a,” “an,” and “the,” also refer to one or more unless expressly specified otherwise.

In addition, as used herein, the term, “set,” can mean one or more, unless expressly specified otherwise. The term, “sets,” can mean multiples of or a plurality of one or mores, ones or more, and/or ones or mores consistent with set theory, unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatus, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

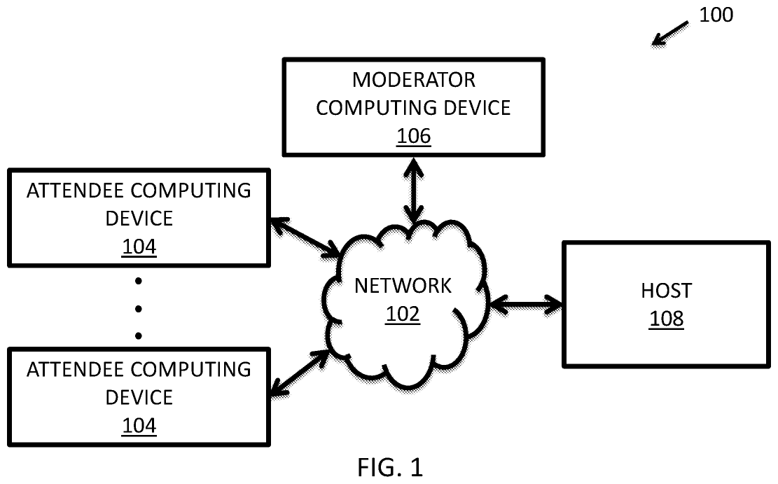

With reference to the drawings, FIG. 1 is a schematic block diagram of one embodiment of a computing system 100 (and/or computing network 100) that can learn, identify, and launch operations in a digital learning environment. At least in the illustrated embodiment, the computing system 100 includes, among other components, a network 102 connecting a set of one or more attendee computing devices 104 (also simply referred individually, in various groups, or collectively as attendee computing device(s) 104), a moderator computing device 106, and a host computing device 108 and/or host computing system 108 (or simply, host 108), and to one another.

The network 102 may include any suitable wired and/or wireless network 102 (e.g., public and/or private computer networks in any number and/or configuration (e.g., the Internet, an intranet, a cloud network, etc.)) that is known or developed in the future that enables the set of attendee computing devices 104, the host 108, and the moderator computing device 106 to be coupled to and/or in communication with one another and/or to share resources. In various embodiments, the network 102 can comprise the Internet, a cloud network (IAN), a wide area network (WAN), a local area network (LAN), a wireless local area network (WLAN), a metropolitan area network (MAN), an enterprise private network (EPN), a virtual private network (VPN), and/or a personal area network (PAN), among other examples of computing networks and/or or sets of computing devices connected together for the purpose of communicating (e.g., digital learning environment) with one another that are possible and contemplated herein.

An attendee computing device 104 may include any suitable computing system and/or computing device capable of accessing and/or communicating with one another, the moderator computing device 106, and the host 108 the via the network 102. Examples of an attendee computing device 104 include, but are not limited to, a laptop computer, a desktop computer, a personal digital assistant (PDA), a tablet computer, a smart phone, a cellular telephone, a smart television (e.g., televisions connected to the Internet), a wearable, an Internet of Things (IoT) device, a game console, a vehicle on-board computer, a streaming device, a smart device, and a digital assistant, etc., among other computing devices that are possible and contemplated herein.

System 100 may include any suitable quantity of attendee computing devices 104. That is, while system 100 is illustrated in FIG. 1 as including two (2) attendee computing devices 104, the various embodiments are not limited to two attendee computing devices 104. In other words, various other embodiments of the system 100 may include one (1) attendee computing device 104 or any quantity of attendee computing devices 104 greater than two attendee computing devices 104.

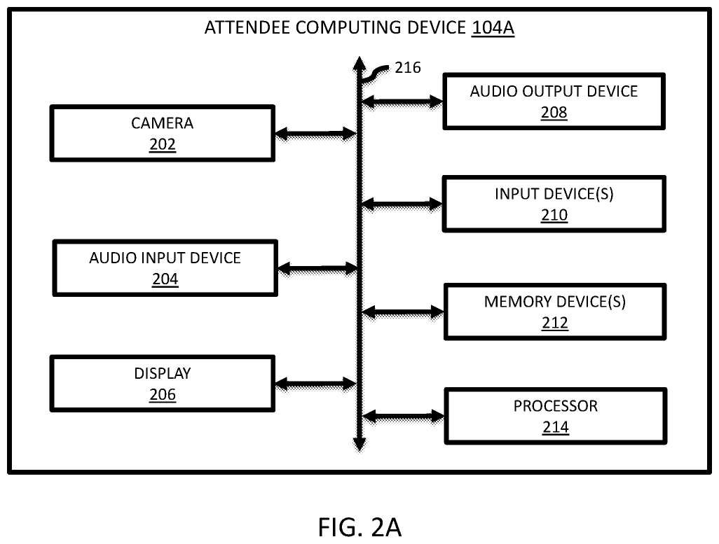

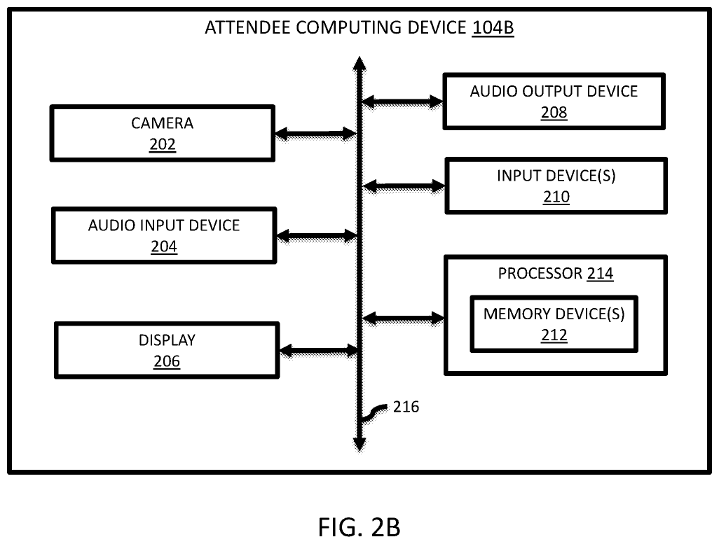

With reference to FIG. 2A, FIG. 2A is a block diagram of one embodiment of an attendee computing device 104A. At least in the illustrated embodiment, the attendee computing device 104A includes, among other components, a camera 202, an audio input device 204, a display 206, an audio output device 208, one or more input devices 210, one or more memory devices 212, and a processor 214 coupled to and/or in communication with one another via a bus 216 (e.g., a wired and/or wireless bus).

A camera 202 may include any suitable device that is known or developed in the future capable of capturing and transmitting images, video feeds, and/or video streams. In various embodiments, the camera 202 includes at least one video camera.

An audio input device 204 may include any suitable device that is known or developed in the future capable of capturing and transmitting audio/sound, audio feeds, and/or audio streams. In various embodiments, the audio input device 204 includes at least one microphone.

A display 206 may include any suitable device that is known or developed in the future capable of displaying images/data, video/data feeds, and/or video/data streams. In various embodiments, the display 206 may include an internal display or an external display. In some embodiments, the display 206 is configured to display a video/data feed of the attendees (e.g., students, workers, adults, children, colleagues, etc.) and/or the moderator (e.g., an adult, a teacher, a boss, an individual in charge, etc.) of a digital learning environment (e.g., a virtual learning system, a virtual learning platform, virtual learning application/software, a classroom management system, a classroom management platform, classroom management software/application, online learning system, online learning platform, online learning application/software, a distance learning system, a distance learning platform, distance learning application/software, a video conference system, a video conference platform, digital learning environment application/software, a virtual classroom, a virtual meeting, etc., and/or the like digital learning environments or digital environments) while the digital learning environment is in progress.

An audio output device 208 may include any suitable device that is known or developed in the future capable of receiving and providing audio/sound, audio feeds, and/or audio streams. In various embodiments, the audio output device 208 includes a speaker, a set of headphones, and/or a set of earbuds, etc., among other suitable audio output devices that are possible and contemplated herein.

An input device 210 may include any suitable device that is known or developed in the future capable of receiving user input. In various embodiments, the output device 210 includes a keyboard, a mouse, a trackball, a joystick, a touchpad, and/or a touchscreen, etc., among other suitable input devices that are possible and contemplated herein.

A set of memory devices 212 may include any suitable quantity of memory devices 212. Further, a memory device 212 may include any suitable type of device and/or system that is known or developed in the future that can store computer-useable and/or computer-readable code. In various embodiments, a memory device 212 may include one or more non-transitory computer-usable mediums (e.g., readable, writable, etc.), which may include any non-transitory and/or persistent apparatus or device that can contain, store, communicate, propagate, and/or transport instructions, data, computer programs, software, code, routines, etc., for processing by or in connection with a computer processing device (e.g., processor 214).

A memory device 212, in some embodiments, includes volatile computer storage media. For example, a memory device 212 may include random access memory (RAM), including dynamic RAM (DRAM), synchronous dynamic RAM (SDRAM), and/or static RAM (SRAM). In other embodiments, a memory device 212 includes non-volatile computer storage media. For example, a memory device 212 may include a hard disk drive, a flash memory, and/or any other suitable non-volatile computer storage device that is known or developed in the future. In various embodiments, a memory device 212 includes both volatile and non-volatile computer storage media.

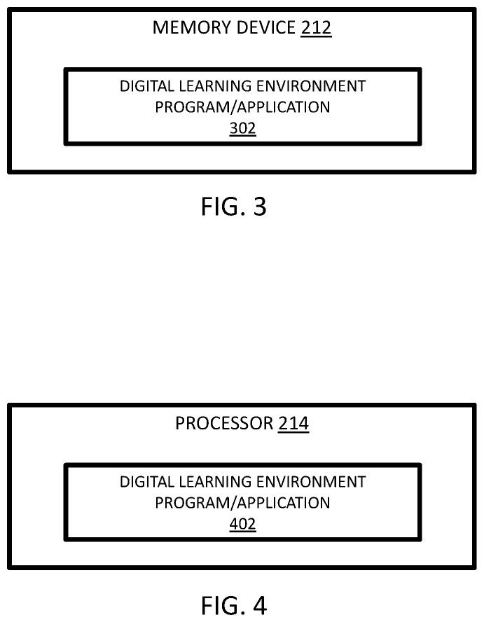

With reference now to FIG. 3, FIG. 3 is a schematic block diagram of one embodiment of a memory device 212A. At least in the illustrated embodiment, the memory device 212A includes, among other components, a digital learning environment program and/or application 302, that is configured to operate/function when executed by the processor 214.

A digital learning environment program/application 302 may include any suitable commercial and/or private digital learning environment program and/or application that is known or developed in the future. Examples of a digital learning environment program/application 302 include, but are not limited to, LanSchool®, Google Classroom™, Blackboard®, Microsoft Teams®, Zoom®, Google Meet®, Cisco Webex®, GoToMeeting®, Skype®, etc., and/or the like digital learning environment programs/applications, each of which is contemplated herein. In some embodiments, the digital learning environment program/application 302 can include an enterprise and/or proprietary digital learning environment program and/or application.

In various embodiments, a digital learning environment program/application 302 is configured to utilize the camera 202 and the audio input device 204 to capture one or more images and one or more audios/sounds, respectively, and generate a video feed and/or video stream that includes the captured image(s) and audio(s)/sound(s) (e.g., of a user). The video feed and/or video stream that includes the captured image(s) and audio(s)/sound(s) of the user can include the behavior(s) (e.g., voice, gestures, etc.) of the user in real-time during the digital learning environment. The digital learning environment program/application 302, in some embodiments, is further configured to transmit the video feed and/or video stream to one or more other attendee computing devices 104, the moderator computing device 106 (e.g., used by a teacher, supervisor, colleague, etc.), and the host 108.

In various embodiments, the digital learning environment program/application 302 is further configured to receive video feeds and/or video streams from one or more other attendee computing devices 104 and/or the moderator computing device 106. The digital learning environment program/application 302 is also configured to utilize the display 206 and the audio output device 208 to display the image(s) and play the audio(s)/sound(s), respectively, in the received video feed and/or video stream (e.g., to a user).

The user behavior(s) captured by the camera 202 and/or input device 204, at various times, may include any suitable behavior(s) and/or interaction(s) that can occur in a digital learning environment. For example, the user behavior(s) may include the user literally and/or figuratively (e.g., electronically) raising their hand, asking a question, providing an answer, making a suggestion, and/or providing additional material(s)/information/resource(s), etc., among other behaviors and/or interactions that are possible and contemplated herein. In various embodiments, a set of one or more auditory cues and/or one or more visual cues can define the user's behavior(s) and/or interactions.

Auditory cues can include, but are not limited to, any type of word(s), sound(s), and/or noise(s), etc., whether generated by a human (e.g., analog cues) and/or by a non-human (e.g., digital cues via a computing device/machine, a mechanical device/machine, etc.). Visual cues can include, but are not limited to, any type of gesture(s), typed message (e.g., chat, instant message, private message, etc.), picture(s), video(s), and/or other visual representation(s), etc., whether generated by a human (e.g., analog cues) and/or a non-human (e.g., digital cues via a computing device/machine, a mechanical device/machine, etc.).

An attendee computing device 104 that generates and transmits a video feed and/or video stream that includes behavior exhibited by its user can be referred to herein as, a source attendee computing device 104. An attendee computing device 104 that receives and/or is used by an attendee that is the target of any behavior included in a video feed and/or video stream from one or more source attendee computing devices 104 can be referred to herein as, a target attendee computing device 104. The moderator computing device 106 and/or the user (e.g., the moderator) of the moderator computing device 106 can also be the target of the behavior included in a video feed and/or video stream from one or more source attendee computing devices 104.

Referring back to FIG. 2A, a processor 214 may include any suitable non-volatile/persistent hardware and/or software configured to perform and/or facilitate performing various processing functions and/or operations. In various embodiments, the processor 214 includes hardware and/or software for executing instructions in one or more digital learning environment modules and/or applications. The digital learning environment modules and/or applications executed by the processor 214 can be stored on and executed from a memory device 212 and/or from the processor 214.

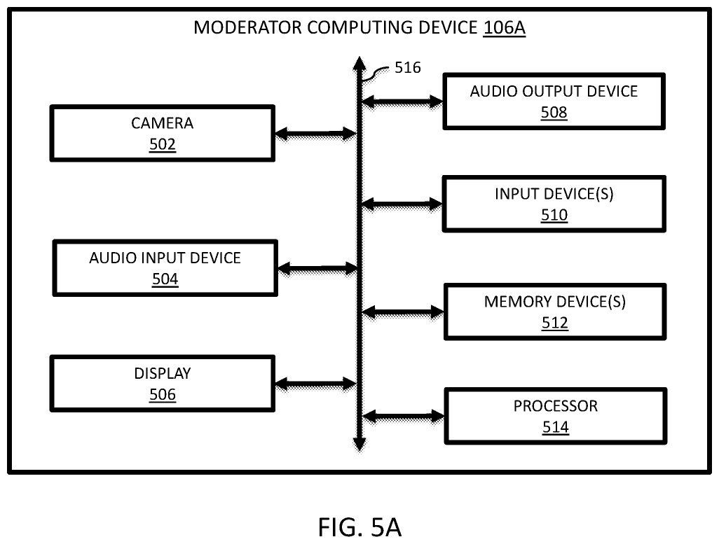

With reference to FIG. 4, FIG. 4 is a schematic block diagram of one embodiment of a processor 214. At least in the illustrated embodiment, the processor 214 includes, among other components, a digital learning environment program/application 402 similar to the digital learning environment program/application 302 in the memory device 212 discussed with reference to FIG. 3.

Referring to FIG. 2B, FIG. 2B is a block diagram of another embodiment of an attendee computing device 104B. The attendee computing device 104B includes, among other components, a camera 202, an audio input device 204, a display 206, an audio output device 208, one or more input devices 210, one or more memory devices 212, and a processor 214 coupled to and/or in communication with one another via a bus 216, similar to the camera 202, audio input device 204, display 206, audio output device 208, input device(s) 210, memory device(s) 212, processor 214, and bus 216 discussed with reference to the attendee computing devices 104A illustrated in FIG. 2A. Alternative to the attendee computing device 104A, the processor 214 in the attendee computing device 104B includes the memory device(s) 212 as opposed to the memory device(s) 212 of the attendee computing device 104A being a different device than and/or independent of the processor 214.

With reference again to FIG. 1, a moderator computing device 106 may include any suitable computing system and/or computing device capable of accessing and/or communicating with the attendee computing devices 104 and the host 108 via the network 102. Examples of a moderator computing device 106 include, but are not limited to, a laptop computer, a desktop computer, a PDA, a tablet computer, a smart phone, a cellular telephone, a smart television, a wearable, an IoT device, a game console, a vehicle on-board computer, a streaming device, a smart device, and a digital assistant, etc., among other computing devices that are possible and contemplated herein.

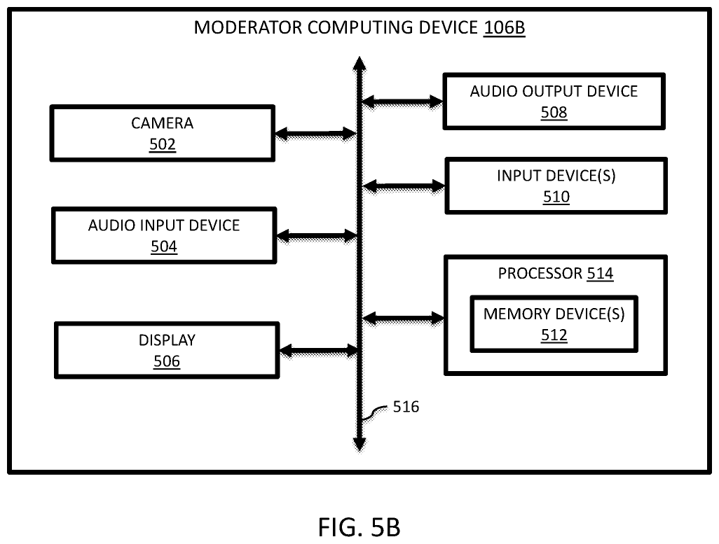

With reference to FIG. 5A, FIG. 5A is a block diagram of one embodiment of a moderator computing device 106A. The moderator computing device 106A includes, among other components, a camera 502, an audio input device 504, a display 506, an audio output device 508, and one or more input devices 510 coupled to and/or in communication with one another via a bus 516 (e.g., a wired and/or wireless bus), similar to the camera 202, audio input device 204, display 206, audio output device 208, input device(s) 210, and bus 216 discussed with reference to the attendee computing device 104A illustrated in FIG. 2A. At least in the illustrated embodiment, the moderator computing device 106A further includes, among other components, one or more memory devices 512 and a processor 514 coupled to an in communication with one another and with the camera 502, audio input device 504, display 506, audio output device 508, and input device(s) 510 via the bus 516.

A set of memory devices 512 may include any suitable quantity of memory devices 512. Further, a memory device 512 may include any suitable type of device and/or system that is known or developed in the future that can store computer-useable and/or computer-readable code. In various embodiments, a memory device 512 may include one or more non-transitory computer-usable mediums (e.g., readable, writable, etc.), which may include any non-transitory and/or persistent apparatus or device that can contain, store, communicate, propagate, and/or transport instructions, data, computer programs, software, code, routines, etc., for processing by or in connection with a computer processing device (e.g., processor 514).

A memory device 512, in some embodiments, includes volatile computer storage media. For example, a memory device 512 may include RAM, including DRAM, SDRAM, and/or SRAM. In other embodiments, a memory device 512 includes non-volatile computer storage media. For example, a memory device 512 may include a hard disk drive, a flash memory, and/or any other suitable non-volatile computer storage device that is known or developed in the future. In various embodiments, a memory device 512 includes both volatile and non-volatile computer storage media.

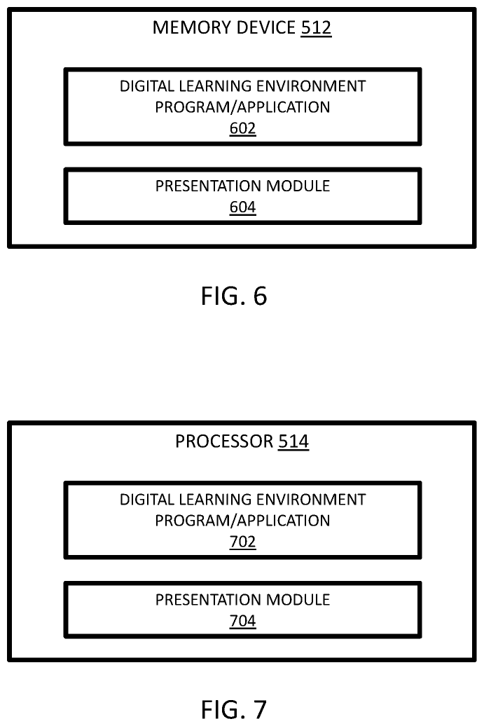

With reference now to FIG. 6, FIG. 6 is a schematic block diagram of one embodiment of a memory device 512. The memory device 512 includes, among other components, a digital learning environment program and/or application 602 similar to the digital learning environment program and/or applications 302 discussed elsewhere herein. At least in the illustrated embodiment, the memory device 512 further includes, among other components, a presentation module 604 that is configured to operate/function when executed by the processor 514.

A presentation module 604 may include any suitable hardware and/or software than can receive and/or store data, information, and/or resource(s). In various embodiments, the data, information, and/or resource(s) in the presentation module 604 define one or more presentations for the user of the moderator computing device 106.

A presentation can include any suitable type or presentation and/or presentation that is known or developed in the future. In various embodiments, a presentation can include instruction in a business, government, religious, and/or educational institution.

The presentation may include any suitable material, format, and/or resources that are known or developed in the future. For example, the presentation can include one or more digital slides, one or more videos, one or more audio-visual feeds, one or more digital handouts, one or more one web sites and/or web addresses, and/or one or more links to one or more websites/web addresses, etc., among other materials and/or resources that are possible and contemplated herein.

In some embodiments, each separate type of material or item of material, type of format or item of format, and/or type of resource or item of resource can define an operation for a presentation. In additional or alternative embodiments, an operation can include any suitable transition and/or mechanism that can assist in the flow of a presentation. For example, an operation can include one or more visual cues (e.g., a blank screen, a picture, video, color, highlight, etc.) and/or one or more auditory cues (e.g., a sound or silence, music, a volume, etc.), among other mechanisms that can assist in the flow of a presentation.

In still further additional or alternative embodiments, an operation can include an event and/or a trigger. For example, an operation can include one or more time or timing elements (e.g., a beginning time, an intermission, a break, a transition time, and/or an ending time, etc.).

A trigger can include any suitable trigger that is known or developed in the future. For example, a trigger can include any suitable event, a user behavior (e.g., one or more behaviors of an attendee and/or moderator), one or more visual cues, and/or one or more auditory cues, etc., among other triggers that are possible and contemplated herein.

A presentation, in various embodiments, can include a set of one or more operations that the moderator/instructor intends to follow in presenting the material and/or resource(s) to the attendee(s)/student(s). In some embodiments, the set of operations include a predetermined and/or predefined order (e.g., sequential order) that the material and/or resource(s) are to be presented to the attendees (e.g., via the attendee computing device(s) 104. In additional or alternative embodiments, the set of operations define a flow for a presentation.

In certain embodiments, the presentation can include a lesson plan for an instructor or teacher. In a non-limiting example, a lesson plan can include, among other operations and/or elements, 1) turning ON a blank screen for each attendee computing device 104; 2) waiting an amount of time; 3) turning OFF the blank screen for each attendee computing device 104; 4) performing operations (e.g., click(s)) for website pushing to each attendee computing device 104 (e.g., specifying and submitting the web address or Uniform Resource Locator (URL) of a particular pushed website, performing (e.g., click) web limiting configuration options for the website, switching the web limiting configuration options to “Allow Only”, adding the particular website to a list of websites, ensuring that the particular website is active, and turning OFF the other websites in the list of websites); 5) turning ON web limiting functions/operations; 6) lecture and/or open discussion; 7) generate (e.g., type and/or verbal) and transmit instructions to attendee computing device(s) 104; 8) waiting an amount (predetermined) of time (e.g., 30 minutes or other suitable amount of time); turning OFF web limiting; and reconfiguring the list of web sites (e.g., remove/delete the particular web site so that the list of web sites is returned to its previous state), among other operations and/or elements that are possible and contemplated herein.

In some embodiments, the moderator/instructor manually performs the operations of a presentation (e.g., lesson plan). The various embodiments discussed herein enable and/or allow for automatic and/or automation of these operations.

At times, the moderator/instructor may modify a presentation in real time and/or on-the-fly modify by supplementing the presentation with one or more additional operations, materials, and/or resources to the presentation and/or subtracting one or more operations, materials, and/or resources from the presentation. The various embodiments discussed herein enable and/or allow for automatic and/or automation of these operations.

In certain embodiments, the moderator/instructor manually modifies (e.g., in real time and/or on-the-fly modify) the presentation during the digital learning environment. The manual modification may include the addition and/or subtraction of one or more operations and/or materials to the presentation. The various embodiments discussed herein enable and/or allow the automated and/or automatic addition/subtraction of these operations.

In some embodiments, a modification can be triggered by and/or result from one or more happenings during the digital learning environment. A happening may include any suitable action, behavior, event, and/or occurrence, etc. that can happen during a digital learning environment. Example happenings can include, but are not limited to, a discussion (e.g., a topic), a question, one or more actions of one or more attendees and/or the moderator, a visual trigger (e.g., a picture, photo, video, data/information, etc.), an auditory trigger (e.g., a word, sound, etc.), use of a resource (e.g., a website, a publication, etc.), and/or reference to a resource, etc., among other actions, behaviors, events, and/or occurrences that are possible and contemplated herein.

Referring back to FIG. 5A, a processor 514 may include any suitable non-volatile/persistent hardware and/or software configured to perform and/or facilitate performing processing functions and/or operations. In various embodiments, the processor 514 includes hardware and/or software for executing instructions in one or more modules and/or applications that can perform and/or facilitate performing functions and/or operations for a digital learning environment. The modules and/or applications executed by the processor 514 can be stored on and executed from a memory device 512 and/or from the processor 514.

With reference to FIG. 7, FIG. 7 is a schematic block diagram of one embodiment of a processor 514. At least in the illustrated embodiment, the processor 514 includes, among other components, a digital learning environment program and/or application 702 and a presentation module 704 similar to the digital learning environment program and/or application 602 and presentation module 604 discussed with reference to FIG. 6.

Referring to FIG. 5B, FIG. 5B is a block diagram of another embodiment of a moderator computing device 106B. The moderator computing device 106B includes, among other components, a camera 502, an audio input device 504, a display 506, an audio output device 508, one or more input devices 510, one or more memory devices 512, and a processor 514 coupled to and/or in communication with one another via a bus 516, similar to the camera 502, audio input device 504, display 506, audio output device 508, input device(s) 510, memory device(s) 512, processor 514, and bus 516 discussed with reference to the moderator computing device 106A illustrated in FIG. 5A. Alternative to the moderator computing device 106A, the processor 514 in the moderator computing device 106B includes the memory device(s) 512 as opposed to the memory device(s) 512 of the moderator computing device 106A being a different device than and/or independent of the processor 514.

Referring again to FIG. 1, a host 108 may include any suitable computer hardware and/or software that can learn, identify, and launch operations in a digital learning environment (e.g., a virtual classroom, virtual meeting, etc.). In various embodiments, the host 108 includes computer hardware and/or software that can automatedly (e.g., without human and/or user input and/or intervention) and/or automatically (e.g., without human and/or user input and/or intervention) learn, identify, and launch operations in a digital learning environment.

A host 108, in various embodiments, can include one or more processors, computer-readable memory, and/or one or more interfaces, among other features and/or hardware. A host 108 can further include any suitable software component or module, or computing device(s) that is/are capable of hosting and/or serving a software application or services, including distributed, enterprise, and/or cloud-based software applications, data, and services. For instance, a host 108 can be configured to host, serve, or otherwise manage digital learning environments, or applications interfacing, coordinating with, or dependent on or used by other services, including digital learning environment applications and software tools for a digital learning environment. In some instances, a host 108 can be implemented as some combination of devices that can comprise a common computing system and/or device, server, server pool, or cloud computing environment and share computing resources, including shared memory, processors, and interfaces.

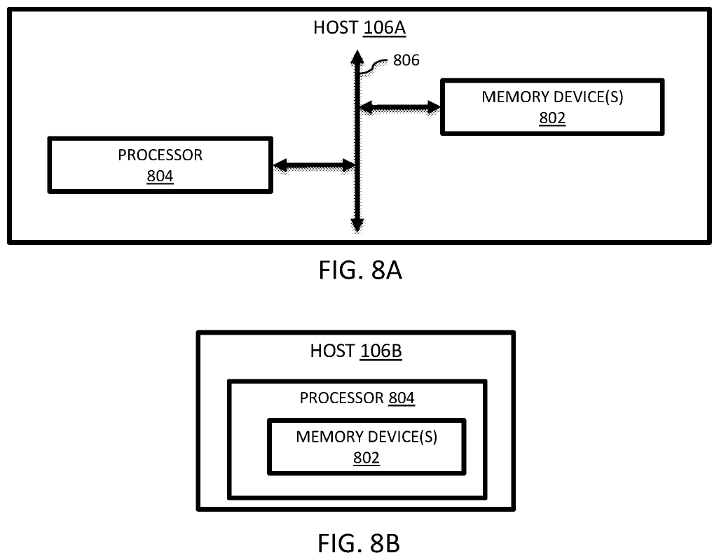

Referring to FIG. 8A, FIG. 8A is a block diagram of one embodiment of a host 108A. At least in the illustrated embodiment, the host 108A includes, among other components, a set of one or more memory devices 802 and a processor 804 coupled to and/or in communication with one another via a bus 806 (e.g., a wired and/or wireless bus).

A set of memory devices 802 may include any suitable quantity of memory devices 802. Further, a memory device 802 may include any suitable type of device and/or system that is known or developed in the future that can store computer-useable and/or computer-readable code. In various embodiments, a memory device 802 may include one or more non-transitory computer-usable mediums (e.g., readable, writable, etc.), which may include any non-transitory and/or persistent apparatus or device that can contain, store, communicate, propagate, and/or transport instructions, data, computer programs, software, code, routines, etc., for processing by or in connection with a computer processing device (e.g., processor 804).

A memory device 802, in some embodiments, includes volatile computer storage media. For example, a memory device 802 may include RAM, including DRAM, SDRAM, and/or SRAM. In other embodiments, a memory device 802 includes non-volatile computer storage media. For example, a memory device 802 may include a hard disk drive, a flash memory, and/or any other suitable non-volatile computer storage device that is known or developed in the future. In various embodiments, a memory device 802 includes both volatile and non-volatile computer storage media.

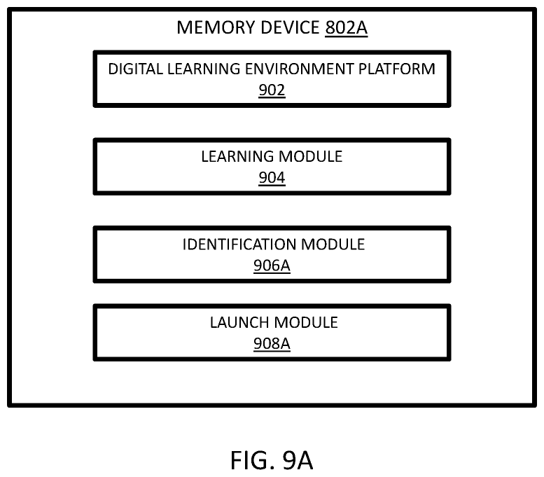

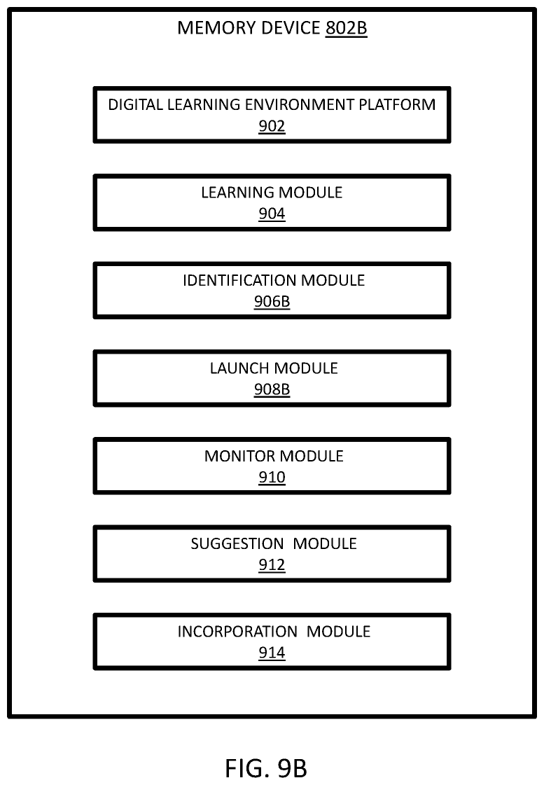

With reference now to FIG. 9A, FIG. 9A is a schematic block diagram of one embodiment of a memory device 802A. At least in the illustrated embodiment, the memory device 802A includes, among other components, a digital learning environment platform 902, a learning module 904, an identification module 906A, and a launch module 908A that are each configured to operate/function in conjunction with one another when executed by the processor 804 to learn, identify, and launch operations and/or facilitate learning, identifying, and launching operations in a digital learning environment. In various embodiments, the learning module 904, identification module 906A, and launch module 908A are each configured to operate/function in conjunction with one another when executed by the processor 804 to automatedly and/or automatically learn, identify, and launch operations in a digital learning environment and/or facilitate learning, identifying, and launching operations in a digital learning environment.

A digital learning environment platform 902 may include any suitable commercial, private, and/or enterprise digital learning environment program and/or application that is known or developed in the future. In various embodiments, a digital learning environment platform 902 is configured to transmit the video feeds and/or video streams generated by the attendee computing device(s) 104 and the moderator computing device 106 to one another.

The video feed and/or video stream generated by each attendee computing device 104 (e.g., a source computing device) and the moderator computing device 106 can include audio and/or video of its user (e.g., attendee or moderator) and/or written/digital messages input by the attendee or moderator. The audio, video, and/or messages of each user of an attendee computing device 104 or moderator computing device 106 can represent and/or convey the behavior(s) of the user (e.g., a student, worker, colleague, peer, etc.) of an attendee computing device 104 or the user (e.g., instructor, teacher, supervisor, peer, presenter, etc.) of a moderator computing device 106 and/or the interaction(s) between the attendee(s) and the moderator.

A learning module 904 may include any suitable hardware and/or software that can learn a presentation, lesson plan, and/or lesson conducted in a digital learning environment. The learning module 904 can learn a presentation conducted in a digital learning environment using any suitable hardware, software, technique, method, and/or process that is known or developed in the future.

The learning module 904, in some embodiments, is configured to receive a signal (e.g., a presentation signal) from a monitoring module 910 (see, e.g., FIG. 9B). The presentation signal received from the monitor module 910, in various embodiments, includes data and/or information about a presentation (lesson, and/or lesson plan) conducted in a digital learning environment that was monitored by the monitoring module 910, as discussed elsewhere herein. The learning module 904 is configured to use the data and/or information about the presentation in the presentation signal to learn the presentation and/or one or more operations included in the presentation.

In various embodiments, the learning module 904 is configured to learn the content and/or operations of a presentation conducted in a digital learning environment. The learning module 904, in certain embodiments, is configured to learn the order, sequence, and/or flow of a presentation conducted in a digital learning environment, which can further include the sequential order of the operations included in the presentation.

In some embodiments, the learning module 904 is configured to learn the content and/or operations of a lesson plan for a lesson conducted in a virtual classroom (e.g., via a digital learning environment). The learning module 904, in certain embodiments, is configured to learn the order, sequence, and/or flow of a lesson plan for a lesson conducted in a virtual classroom, which can further include the sequential order of the operations included in the lesson and/or lesson plan.

In various embodiments, the learning module 904 includes one or more artificial intelligence (AI) algorithms configured to and capable of learning the presentation (or less and/or lesson plan) conducted in a digital learning environment. The AI algorithm(s) may include any suitable AI algorithm(s) that is/are known or developed in the future capable of learning a presentation, lesson, and/or lesson plan conducted in a digital learning environment. Example AI algorithms include, but are not limited to, one or more deep learning algorithms, one or more neural networks, one or more computer vision algorithms, and/or natural language processing algorithms, etc., among other AI algorithms that are possible and contemplated herein.

In certain embodiments, the learning module 904 (and/or AI algorithm(s)) includes and/or implements one or more machine learning (ML) algorithms configured to and/or capable of learning the presentation (or lesson plan) conducted in a digital learning environment. The machine learning algorithm(s) may include any suitable machine learning algorithm(s) that is/are known or developed in the future capable of learning a presentation conducted in a digital learning environment. Example machine learning algorithms include, but are not limited to, supervised machine learning algorithms (e.g., tree based, linear based, etc.) and unsupervised machine learning algorithms (e.g., clustering, association, etc.), among other types of machine learning algorithms that are possible and contemplated herein.

In some embodiments, the learning module 904 is configured to learn a presentation (or lesson plan) conducted in a digital learning environment using Pattern Recognition. For example, a teacher always does operations X-Y-Z in a particular order, the AI/ML starts to learn from this, implements the operations to automate X-Y-Z, and suggests X-Y-Z in the future to the teacher.

In certain embodiments, the learning module 904 is configured to learn a presentation (or lesson plan) conducted in a digital learning environment using Lesson Plan Discovery. For example, using data derived from lesson plans, suggestions and/or material can be presented forth to the teacher to use in conjunction with classroom management functions (such as, for example, push a website, sending information to the chat window, notification reminders, web limiting, etc.).

In further embodiments, the learning module 904 is configured to learn a presentation (or lesson plan) conducted in a digital learning environment using Voice analysis. For example, active listening methodologies can help identify and/or determine contextual suggestions and actions the teacher may be able to utilize in relation to the class, student, subject, and/or environment they may be currently within.

In still other embodiments, the learning module 904 is configured to learn a presentation (or lesson plan) conducted in a digital learning environment using Classroom analysis comparisons. For example, using AI/ML algorithms, analysis on actions taken within similar classroom environments may be compared and suggested in similar situations and/or circumstances.

The various embodiments of a learning module 904 are not limited to the above examples. That is, the various embodiments contemplate and include any suitable ML algorithm, AI algorithm, learning method, learning process, and/or learning technique that is known or developed in the future capable of learning a presentation, lesson, and/or lesson plan.

An identification module 906A may include any suitable hardware and/or software that can identify and/or recognize a presentation, lesson, and/or lesson plan in a digital learning environment. The identification module 906A may identify and/or recognize a presentation, lesson, and/or lesson plan using any suitable algorithm, method, technique, and/or process that is known or developed in the future capable of learning such.

In various embodiments, the identification module 906A is configured to identify a presentation, lesson, and/or lesson plan based on one or more features of the presentation, lesson, lesson plan, and/or a digital learning environment. The feature(s) of a presentation, lesson, lesson plan, and/or digital learning environment may include any suitable feature(s) that is/are known or developed/discovered in the future capable of identifying an operation and/or trait of a presentation, lesson, and/or lesson plan and/or identifying an operation and/or trait of a digital learning environment. Example features can include, but are not limited to, a time (e.g., a relative time (e.g., beginning, ending, etc.), a timing, a time of day, etc.), a visual cue, an auditory cue, a tactile cue, an input, an output, a function, a type of function, a piece of computer code, a type of computer code, an algorithm, a type of algorithm, a program, a type of program, an application, a type of application, a platform, a type of platform, a user, a type of user, a computing device, a type of computing device, a piece of data, a type of data, a content, a type of content, a topic, a type of topic, a resource, a type of resource, and/or the like identifiers, traits, and/or features that are possible, each of which is contemplated herein.

In various embodiments, the identification module 906A is configured to receive a signal (e.g., a features signal) from a monitoring module 910. The features signal received from the monitoring module 910, in certain embodiments, includes, among other data, information, and/or elements, data representing one or more features of a presentation, lesson, and/or lesson plan and/or data representing the feature(s) of one or more operations performed during a digital learning environment, presentation, lesson, and/or lesson plan, as discussed elsewhere herein.

In some embodiments, the identification module 906A is configured to identify a presentation, lesson, and/or lesson plan based on the feature(s) included in the features signal received from the monitoring module 910. In certain embodiments, the identification module 906A is configured to identify a presentation, lesson, and/or lesson plan by comparing the feature(s) of a digital learning environment, presentation, lesson, and/or lesson plan included in the features signal received from the monitoring module 910 and the feature(s) of a known/learned operation, presentation, lesson, lesson plan, and/or digital learning environment to determine a match. Here, the identification module 906A can identify a presentation, lesson, and/or lesson plan in response to one or more features of the comparison matching. Conversely, the identification module 906A may not identify a presentation, lesson, and/or lesson plan in response to one or more features (including all features) of the comparison not matching or failing to match.

The identification module 906A, in various embodiments, is configured to generate and transmit a signal (e.g., an identification signal) to the launch module 908A in response to identifying a presentation, lesson, and/or lesson plan. In certain embodiments, the identification signal can identify and/or recognize a particular learned and/or known presentation, lesson, lesson plan, and/or digital learning environment.

A launch module 908A may include any suitable hardware and/or software that can launch a presentation, lesson, and/or lesson plan. In various embodiments, the launch module 908A is configured to receive the identification signal from the identification module 906A and launch the presentation, lesson, and/or lesson plan in response to receiving the identification signal.

In certain embodiments, the launch module 908A is configured to receive the identification signal from the identification module 906A and launch the particular learned and/or known presentation, lesson, and/or lesson plan identified in the identification signal. In various embodiments, the launch module 908A in configured to automatedly and/or automatically launch the particular learned and/or known presentation, lesson, and/or lesson plan for presentation to the attendee(s) (e.g., via their respective attendee computing devices 104) in the learned order, sequence, and/or flow.

In additional or alternative embodiments, the launch module 908A is configured to receive the identification signal from the identification module 906A and launch one or more operations corresponding to the particular learned and/or known presentation, lesson, and/or lesson plan identified in the identification signal. In various embodiments, the launch module 908A in configured to automatedly and/or automatically launch the operation(s) for the particular learned and/or known presentation, lesson, and/or lesson plan for presentation to the attendee(s) (e.g., via their respective attendee computing devices 104) in the learned order, sequence, flow, and/or sequential order.

As discussed, the various embodiments of the learning module 904, identification module 906A, and launch module 908A can operate/function in conjunction with one another to automatedly and/or automatically learn, identify, and launch a presentation, lesson, and/or lesson plan, including the operations of the presentation, lesson, and/or lesson plan in their sequential order. By doing such, the various embodiments of the learning module 904, identification module 906A, and launch module 908A can enable and/or allow a moderator/instructor to better focus on and/or pay more attention to the contents of the presentation, lesson, and/or lesson plan and/or better focus on and/or pay more attention to the attendees of the presentation, lesson, and/or lesson plan than was previously possible.

Referring now to FIG. 9B, FIG. 9B is a block diagram of another embodiment of a memory device 802B. The memory device 802B includes a digital learning environment platform 902 and a learning module 904 similar to the digital learning environment platform 902 and the learning module 904, respectively, included in the memory device 802A discussed elsewhere herein. At least in the illustrated embodiment, the memory device 802B further includes, among other components, a monitor module 910, an identification module 906B, a suggestion module 912, an incorporation module 914, and a launch module 908B that are each configured to operate/function in conjunction with one another when executed by the processor 804 to learn, identify, and launch operations and/or facilitate learning, identifying, and launching operations in a digital learning environment. In various embodiments, the learning module 904, identification module 906B, launch module 908B, monitor module 910, suggestion module 912, and incorporation module 914 are each configured to operate/function in conjunction with one another when executed by the processor 804 to automatedly and/or automatically learn, identify, and launch operations in a digital learning environment and/or facilitate learning, identifying, and launching operations in a digital learning environment.

A monitor module 910 may include any suitable hardware and/or software that can monitor a digital learning environment, presentation, lesson, and/or lesson plan. In various embodiments, the monitor module 910 is configured to monitor the operation(s) performed in a digital learning environment, presentation, lesson, and/or lesson plan.

In certain embodiments, the monitor module 910 is configured to generate data and/or information about a presentation, lesson, and/or lesson plan conducted in a digital learning environment. Further, the monitor module 910 is configured to generate a presentation signal that includes the data and/or information about the presentation, lesson, and/or lesson plan conducted in a digital learning environment. In some embodiments, the monitor module 910 is configured to transmit the presentation signal to the learning module 904, as discussed elsewhere herein.

As further discussed elsewhere herein, the data and/or information about the presentation, lesson, and/or lesson plan conducted in a digital learning environment included in the presentation signal can enable and/or allow the learning module 904 to automatedly and/or automatically learn a presentation, lesson, and/or lesson plan in an order, sequence, and/or flow. As additionally discussed elsewhere herein, the data and/or information about the presentation, lesson, and/or lesson plan conducted in a digital learning environment included in the presentation signal can enable and/or allow the learning module 904 to automatedly and/or automatically learn the operation(s) of a presentation, lesson, and/or lesson plan in a sequential order.

In additional or alternative embodiments, the monitor module 910 is configured to monitor a digital learning environment, presentation, lesson, and/or lesson plan for one or more happenings occurring therein. In various embodiments, the monitor module 910 is configured to, in real-time and/or on-the-fly, generate a signal (e.g., a happenings signal) including data and/or information representing the happening(s) occurring in a digital learning environment, presentation, lesson, and/or lesson plan. Further, the monitor module 910 is configured to transmit (e.g., during the digital learning environment, presentation, lesson, and/or lesson plan) the happenings signal to the identification module 906B for processing therein.

An identification module 906B, in various embodiments, is configured to include the operations and/or functions of the identification module 906A discussed with reference to FIG. 9A. In additional or alternative embodiments, the identification module 906B is configured to receive and process the happenings signal from the monitor module 910.

The identification module 906B, in various embodiments, is configured to identify each happening occurring in a digital learning environment, presentation, lesson, and/or lesson plan. Each happening can be identified using any suitable code, algorithm, technique, method, and/or process that is known or developed in the future capable of identifying an action, behavior, event, and/or occurrence, etc. that can happen during a digital learning environment, presentation, lesson, and/or lesson plan.

In certain embodiments, the identification module 906B is configured to identify a happening occurring in a digital learning environment, presentation, lesson, and/or lesson plan by comparing the feature(s) of the digital learning environment, presentation, lesson, and/or lesson plan included in the happenings signal received from the monitoring module 910 and the feature(s) of known happenings to determine a match. Here, the identification module 906B can identify a happening in response to one or more features of the comparison matching. Conversely, the identification module 906B may not identify a happening in response to one or more features (including all features) of the comparison not matching or failing to match.

The identification module 906B, in various embodiments, is configured to generate a signal (e.g., an occurrence signal) that include data and/or information representing each identified happening in response to identifying the happening(s) occurring in a digital learning environment, presentation, lesson, and/or lesson plan. Further, identification module 906B is configured to transmit the occurrence signal to the suggestion module 912 and the suggestion module 912 configured to receive the occurrence signal for processing therein.

A suggestion module 912 may include any suitable hardware and/or software that can provide and/or make one or more suggestions for modifying a presentation, lesson, and/or lesson plan to a moderator and/or moderator computing device 106. In various embodiments, the suggestion module 912 is configured to make and/or provide each suggested modification to the moderator and/or moderator computing device 106 in response to receiving the happening(s) identified in the occurrence signal.

In certain embodiments, the suggestion(s) for modifying a presentation, lesson, and/or lesson plan are made and/or provided to the moderator and/or moderator computing device 106 in real-time and/or on-the-fly during the digital learning environment, presentation, and/or lesson. Further, each suggestion for modifying a presentation, lesson, and/or lesson plan is based on an identified happening occurring (e.g., in real-time) during a digital learning environment, presentation, and/or lesson.

A modification can include any suitable modification to a presentation, lesson, and/or lesson plan that is known or developed in the future. In various embodiments, a modification includes the addition of and/or deletion of one or more items and/or aspects of a presentation, lesson, and/or lesson plan. For example, a modification can include, but is not limited to, the addition of and/or deletion of one or more topics, content (e.g., data and/or information), one or more resources (e.g., websites, publications, etc.), and/or operations (e.g., blank screen, etc.), etc., among other items and/or aspects of a presentation, lesson, and/or lesson plan that are possible and contemplated herein.

In addition, a suggested modification corresponds to and/or can be associated with a particular happening and/or type of happening. For example, in response to the moderator asking a question that is tangentially related to the topic being discussed during a digital learning environment, presentation, and/or lesson, the suggestion module 912 can suggest (e.g., in real-time and/or one-the-fly) a website as a resource for incorporation into the discussion. In an additional or alternative non-limiting example, in response to an attendee saying/inputting one or more words (e.g., a trigger word/phrase), the suggestion module 912 can suggest (e.g., in real-time and/or one-the-fly) removing potentially controversial and/or offensive content/material from the discussion. In a further additional or alternative non-limiting example, in response to the occurrence of an unexpected event, the suggestion module 912 can suggest (e.g., in real-time and/or one-the-fly) at least temporarily removing a blank screen from or adding a blank screen to the digital learning environment, presentation, and/or lesson.

While the above examples provide specific modifications to a digital learning environment, presentation, lesson, and/or lesson plan, the various embodiments are provided to assist in understanding the various embodiments and not to limit the various embodiments in any manner. That is, the various embodiments discussed herein contemplate and include any suitable modification to a digital learning environment, presentation, lesson, and/or lesson plan consistent with the spirit and scope of the above examples.

The suggestion module 912 is further configured to request and/or wait for a response (e.g., an indication of acceptance or rejection of a suggestion) from the moderator and/or moderator computing device 106 for each of its suggestions and/or suggested modification. In response to the moderator and/or moderator computing device 106 rejecting a suggestion and/or suggested modification, the suggestion module 912 is configured to discard the suggestion and/or take no further action.

In response to the moderator and/or moderator computing device 106 accepting a suggestion and/or suggested modification, the suggestion module 912 is configured to generate a modification signal for transmission to the incorporation module 914 and the launch module 908B for respective processing therein. The modification signal, in various embodiments, can identify the modification(s) and when/where in the digital learning environment, presentation, lesson, and/or lesson plan to perform/make the modification(s). The incorporation module 914 and the launch module 908B are each configured to receive the modification signal.

An incorporation module 914 can include any suitable hardware and/or software that can identify one or more modifications to a digital learning environment, presentation, lesson, and/or lesson plan and when/where in the digital learning environment, presentation, lesson, and/or lesson plan to perform/make the modification(s). In various embodiments, the incorporation module 914 is configured to generate and transmit a signal (e.g., a status signal) to the moderator and/or moderator computing device 106.

The status signal can query the moderator and/or moderator computing device 106 whether the suggestion(s) and/or suggested modifications to the digital learning environment, presentation, lesson, and/or lesson plan are permanent or are subject to one or more temporary conditions (e.g., one-time, a predetermined quantity of times, and/or a predetermined amount of time, etc.). The incorporation module 914 is configured to generate and transmit a signal (e.g., a notification signal) to the launch module 908B that includes a representation of the response (e.g., permanent or temporary modification(s)) from the moderator and/or moderator computing device 106, which can further include the temporary condition(s).

A launch module 908B, in various embodiments, is configured to include the operations and/or functions of the launch module 908A discussed with reference to FIG. 9A. In additional or alternative embodiments, the launch module 908B is configured to receive and process the modification signal and/or the notification signal.

In certain embodiments, the launch module 908B is configured to modify a digital learning environment, presentation, lesson, and/or lesson plan in response to receiving the modification signal from the suggestion module 912. Further, the launch module 908B is configured to modify a digital learning environment, presentation, lesson, and/or lesson plan in accordance with and/or consistent with the modification(s) included, provided, and/or detailed in the modification signal. For example, the launch module 908B may insert and/or add data/content, a resource, and/or operation between two operations, between two resources, or between an operation and a resource during a digital learning environment, presentation, lesson, and/or lesson plan, among other possibilities that are each contemplated herein. Similarly, the launch module 908B may delete and/or remove data/content, a resource, and/or operation from between two operations, from between two resources, or from between an operation and a resource during a digital learning environment, presentation, lesson, and/or lesson plan, among other possibilities that are each contemplated herein.

In some embodiments, the launch module 908B is configured to make the modification(s) to the digital learning environment, presentation, lesson, and/or lesson plan included, provided, and/or detailed in the modification signal in real-time and/or on-the-fly. For example, the launch module 908B may be configured to and/or capable of immediately making the modification(s) to the digital learning environment, presentation, lesson, and/or lesson plan upon receipt of the modification signal from the suggestion module 912.

In additional or alternative embodiments, the launch module 908B is configured to permanently or temporarily modify the digital learning environment, presentation, lesson, and/or lesson plan in response to receiving the notification signal from the incorporation module 914. That is, the launch module 908B is configured to permanently modify the digital learning environment, presentation, lesson, and/or lesson plan in response to the notification signal indicating that the modification(s) are permanent such that subsequent digital learning environments, presentations, lessons, and/or lesson plans will include the modification(s). Similarly, the launch module 908B is configured to temporarily modify the digital learning environment, presentation, lesson, and/or lesson plan in response to the notification signal indicating that the modification(s) are temporary such that one or more subsequent digital learning environments, presentations, lessons, and/or lesson plans may include the modification(s).

As discussed, the various embodiments of the learning module 904, identification module 906B, launch module 908B, monitor module 910, suggestion module 912, and incorporation module 914 can operate/function in conjunction with one another to automatedly and/or automatically learn, identify, and launch a presentation, lesson, and/or lesson plan, including the operations of the presentation, lesson, and/or lesson plan in their sequential order. By doing such, the various embodiments of the learning module 904, identification module 906B, launch module 908B, monitor module 910, suggestion module 912, and incorporation module 914 can enable and/or allow a moderator/instructor to better focus on and/or pay more attention to the contents of the presentation, lesson, and/or lesson plan and/or better focus on and/or pay more attention to the attendees of the presentation, lesson, and/or lesson plan than was previously possible.

Referring back to FIG. 8A, a processor 804 may include any suitable non-volatile/persistent hardware and/or software configured to perform and/or facilitate performing functions and/or operations for monitoring the behavior of attendees of a digital learning environment. In various embodiments, the processor 804 includes hardware and/or software for executing instructions in one or more modules and/or applications that can perform and/or facilitate performing functions and/or operations for learning, identifying, and launching operations in a digital learning environment. The modules and/or applications executed by the processor 804 for performing and/or facilitate performing functions and/or operations to learn, identify, and launch operations in a digital learning environment can be stored on and executed from a memory device 802 and/or from the processor 804.

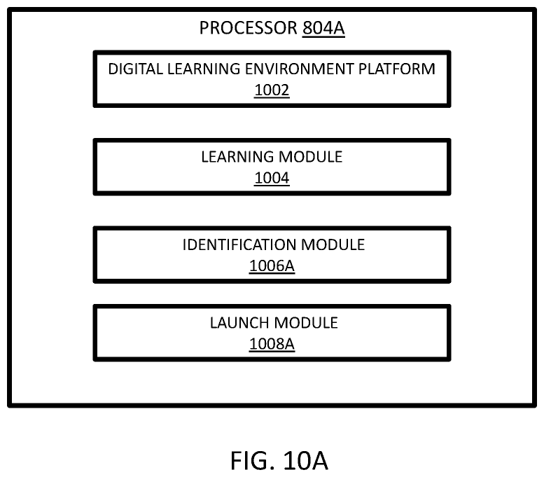

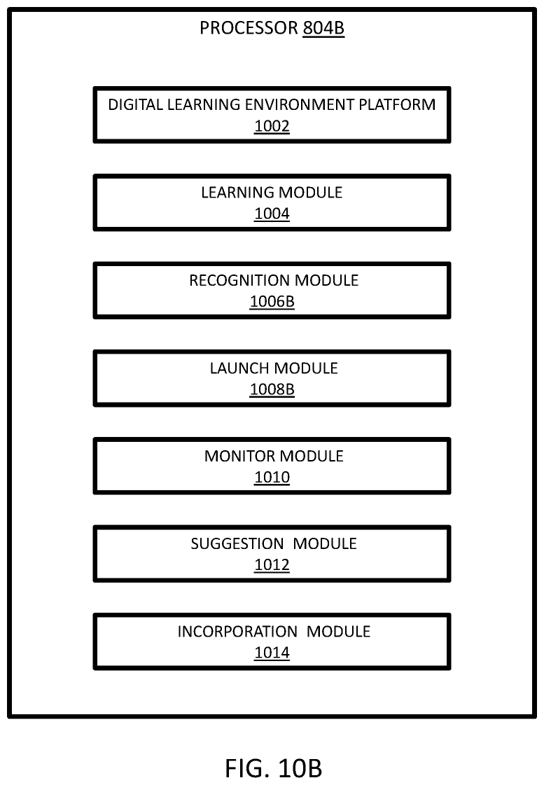

With reference to FIG. 10A, FIG. 10A is a schematic block diagram of one embodiment of a processor 804A. At least in the illustrated embodiment, the processor 804A includes, among other components, a digital learning environment platform 1002, a learning module 1004, an identification module 1006A, and a launch module 1008A similar to the digital learning environment platform 902, learning module 904, identification module 906A, and launch module 908A in the memory device 802A discussed with reference to FIG. 9A.

Referring to FIG. 10B, FIG. 10B is a schematic block diagram of another embodiment of a processor 804B. At least in the illustrated embodiment, the processor 804B includes, among other components, a digital learning environment platform 1002, a learning module 1004, an identification module 1006B, a launch module 1008B, a monitor module 1010, a suggestion module 1012, and an incorporation module 1014 similar to the digital learning environment platform 902, learning module 904, identification module 906B, launch module 908B, monitor module 910, suggestion module 912, and incorporation module 914 in the memory device 802B discussed with reference to FIG. 9B.

Turning now to FIG. 8B, FIG. 8B is a block diagram of another embodiment of a host 108B. The host 108B includes, among other components, a memory 802 and a processor 804. Alternative to the host 108A, the processor 804 in the host 108B includes the memory device 802 as opposed to the memory device 802 of the host 108A being a different device than and/or independent of the processor 804.

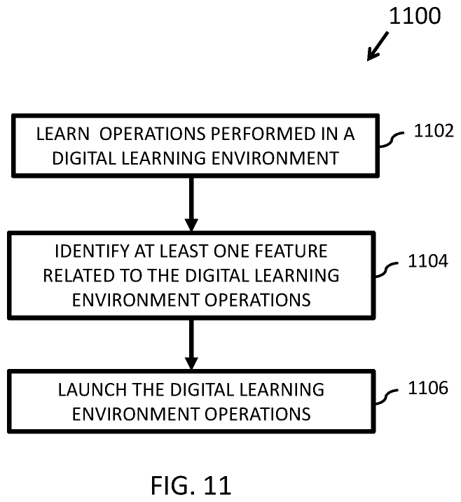

FIG. 11 is a schematic flow chart diagram illustrating one embodiment of a method 1100 for learning, identifying, and launching operations in a digital learning environment. At least in the illustrated embodiment, the method 1100 begins by a processor (e.g., processor 804) learning operations performed in a digital learning environment (block 1102). The digital learning environment may include a presentation, lesson, and/or lesson plan, as discussed elsewhere herein.

Further, the presentation, lesson, and/or lesson plan may be learned in an order, sequence, and/or flow, as discussed elsewhere herein. As further discussed elsewhere herein, the operations may be learned in a sequential order.

The processor 804 can identify at least one feature related to the digital learning environment operations (block 1104). The feature(s) may include any suitable feature and/or features and/or may be identified using any suitable method, technique, and/or process than can identify the digital learning environment operations, as discussed elsewhere herein.

Further, the processor 804 launches the digital learning environment operations for the identified presentation, lesson, and/or lesson plan (block 1106). The operations for the identified presentation, lesson, and/or lesson plan are launched in the digital learning environment in the learned order, sequence, flow, and/or sequential order, as discussed elsewhere herein.

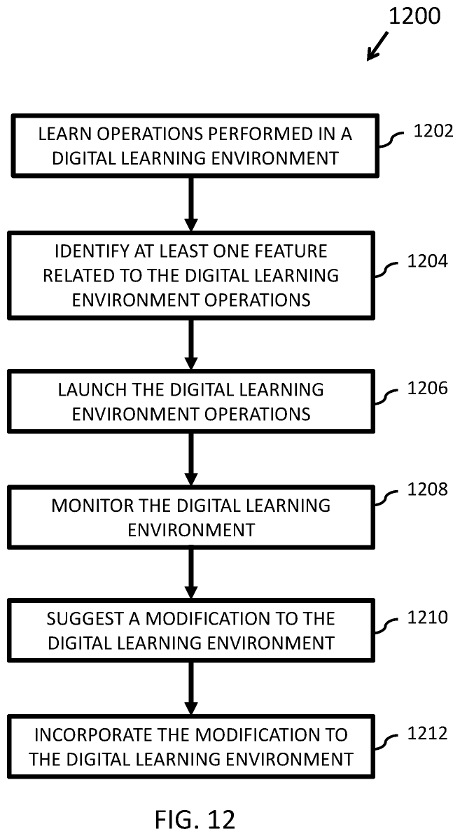

FIG. 12 is a schematic flow chart diagram illustrating another embodiment of a method 1200 for learning, identifying, and launching operations in a digital learning environment. At least in the illustrated embodiment, the method 1200 begins by a processor (e.g., processor 804) learning operations performed in a digital learning environment (block 1202). The digital learning environment may include a presentation, lesson, and/or lesson plan, as discussed elsewhere herein.

Further, the presentation, lesson, and/or lesson plan may be learned in an order, sequence, and/or flow, as discussed elsewhere herein. As further discussed elsewhere herein, the operations may be learned in a sequential order.

The processor 804 can identify at least one feature related to the digital learning environment operations (block 1204). The feature(s) may include any suitable feature and/or features and/or may be identified using any suitable method, technique, and/or process than can identify the digital learning environment operations, as discussed elsewhere herein.

Further, the processor 804 launches the digital learning environment operations for the identified presentation, lesson, and/or lesson plan (block 1206). The operations for the identified presentation, lesson, and/or lesson plan are launched in the digital learning environment in the learned order, sequence, flow, and/or sequential order, as discussed elsewhere herein.

The processor monitors the digital learning environment for the occurrence of happenings (block 1208). In response to the occurrence of a happening, the processor 804 suggests (e.g., to a moderator and/or moderator computing device 106) a modification to the digital learning environment (block 1210). The modification can include one or more modifications to the digital learning environment and/or one or more modifications to a presentation, lesson, and/or lesson plan in the digital learning environment, as discussed elsewhere herein.

In response to the suggestion and/or suggest modification being accepted (e.g., by the moderator and/or moderator computing device 106), the modification is incorporated into the digital learning environment (block 1212). The modification can be permanent or temporary, as discussed elsewhere herein.

As discussed, the various embodiments of the methods 1100 and 1200 can automatedly and/or automatically learn, identify, and launch a presentation, lesson, and/or lesson plan, including the operations of the presentation, lesson, and/or lesson plan in their sequential order. By doing such, the various embodiments of the methods 1100 and 1200 can enable and/or allow a moderator/instructor to better focus on and/or pay more attention to the contents of the presentation, lesson, and/or lesson plan and/or better focus on and/or pay more attention to the attendees of the presentation, lesson, and/or lesson plan than was previously possible.

While the various embodiments discussed herein are referenced as and/or related to a, digital learning environment, the various embodiments are not limited to a digital learning environment. That is, the various embodiments contemplate and include any suitable digital environment.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory configured to store code executable by the processor to:
automatedly learn a sequential order for a set of operations performed in a digital learning environment, the set of operations including at least one feature related to the set of operations,
automatedly identify, at a time subsequent to learning the set of operations in the digital learning environment, the at least one feature related to the set of operations, and
automatedly launch the set of operations for the digital learning environment in the sequential order in response to identifying the at least one feature related to the set of operations at the subsequent time.

2. The apparatus of claim 1, wherein:
the set of operations defines a presentation;
the at least one feature comprises a beginning of the presentation; and
the processor is further configured to monitor happenings during the presentation.

3. The apparatus of claim 2, wherein the processor is further configured to:
automatedly suggest, in real-time, an addition for incorporation into the presentation in response to a happening during the presentation.

4. The apparatus of claim 3, wherein the happening comprises at least one of: a topic discussed during the presentation, a question asked during the presentation, an action performed during the presentation, a trigger word spoken during the presentation, and a resource used during the presentation.

5. The apparatus of claim 3, wherein the processor is further configured to incorporate the addition between operations in the set of operations in response to a user accepting the suggestion.

6. The apparatus of claim 5, wherein the addition is one of temporarily incorporated and permanently incorporated between the operations in response to the user accepting the suggestion.

7. The apparatus of claim 1, wherein the digital learning environment is a virtual classroom.

8. The apparatus of claim 2, wherein the set of operations includes a lesson plan.

9. A method, comprising:
automatedly learning, by a processor, a sequential order for a set of operations performed in a digital learning environment, the set of operations including at least one feature related to the set of operations;
automatedly identifying, at a time subsequent to learning the set of operations in the digital learning environment, the at least one feature related to the set of operations; and
automatedly launching the set of operations for the digital learning environment in the sequential order in response to identifying the at least one feature related to the set of operations at the subsequent time.

10. The method of claim 9, wherein:
the set of operations defines a presentation;
the at least one feature comprises a beginning of the presentation; and
the method further comprises monitoring happenings during the presentation.

11. The method of claim 8, wherein the method further comprises:
automatedly suggesting, in real-time, an addition for incorporation into the presentation in response to a happening during the presentation.

12. The method of claim 11, wherein the happening comprises at least one of: a topic discussed during the presentation, a question asked during the presentation, an action performed during the presentation, a trigger word spoken during the presentation, and a resource used during the presentation.

13. The method of claim 11, wherein the method further comprises:
incorporating the addition between operations in the set of operations in response to a user accepting the suggestion.

14. The method of claim 13, wherein incorporating the addition between the operations in response to the user accepting the suggestion comprises one of:
temporarily incorporating the addition between the operations in response to the user accepting the suggestion; and
permanently incorporating the addition between the operations in response to the user accepting the suggestion.

15. A computer program product comprising a computer-readable storage device including code embodied therewith, the code executable by a processor to cause the processor to:
automatedly learn a sequential order for a set of operations performed in a digital learning environment, the set of operations including at least one feature related to the set of operations;
automatedly identify, at a time subsequent to learning the set of operations in the digital learning environment, the at least one feature related to the set of operations; and
automatedly launch the set of operations for the digital learning environment in the sequential order in response to identifying the at least one feature related to the set of operations at the subsequent time.

16. The computer program product of claim 15, wherein:
the set of operations defines a presentation;
the at least one feature comprises a beginning of the presentation; and
the code further causes the processor to monitor happenings during the presentation.

17. The computer program product of claim 16, wherein the code further causes the processor to:
automatedly suggest, in real-time, an addition for incorporation into the presentation in response to a happening during the presentation.

18. The computer program product of claim 17, wherein the happening comprises at least one of: a topic discussed during the presentation, a question asked during the presentation, an action performed during the presentation, a trigger word spoken during the presentation, and a resource used during the presentation.

19. The computer program product of claim 17, wherein the code further causes the processor to:
incorporate the addition between operations in the set of operations in response to a user accepting the suggestion.

20. The computer program product of claim 19, wherein the code that causes the processor to incorporate the addition between the operations in response to the user accepting the suggestion comprises code that causes the processor to one of:
temporarily incorporate the addition between the operations in response to the user accepting the suggestion; and
permanently incorporate the addition between the operations in response to the user accepting the suggestion.
